(19) United States
(12) Patent Application Publication
(10) Pub. No.: US 2022/0103747 A1
(43) Pub. Date: Mar. 31, 2022

(54) Object Recognition Device

(71) Applicant: Tactracer Co., Ltd., Gyeonggi-do (KR)

(72) Inventor: Chul-Woo Jun, Gyeonggi-do (KR)

(21) Appl. No.: 17/427,077

(22) PCT Filed: Jan. 31, 2020
(86) PCT No.: PCT/KR2020/001451

§ 371 Date: Jul. 29, 2021

(30) Foreign Application Priority Data
Feb. 1, 2019 (KR) 10-2019-0013439

(51) Int. Cl. H04N 5/232; G06K 19/14; G10L 17/22

(52) U.S. Cl. CPC H04N 5/23218; G10L 17/22; G06K 19/145

(57) ABSTRACT

An object recognition device includes: a transfer path including a rail installed above a space in which an object is arranged; a transfer machine that moves along the rail and lowers and supports the wire below the rail; and a detector that is supported by the wire and moves up and down and detects and recognizes the object.

### TECHNICAL FIELD

The present invention relates to an object recognition device.

### BACKGROUND ART

With the advancement in wireless recognition technology using vision-based recognition through a camera or electronic tags such as radio frequency identification (RFID), technologies capable of applying automated systems to collect information on articles displayed or stored are developed.

Conventionally, in order to scan articles on a shelf using a scanning device, the worker has directly scanned the articles using a reader or scanned the articles through a scanning device that moved randomly on the floor.

However, in a space (a store, a pharmacy, a market, a library, etc.) where a plurality of shelves are arranged, it is inefficient to manually scan each of the articles displayed on the shelves.

In addition, devices that scan while moving on the floor are little reliable due to their low rates of recognizing target articles, and their moving lines often overlap those of customers or workers.

### DISCLOSURE

### Technical Problem

The present disclosure provides an object recognition device that reliably and efficiently detects an article, which is an object, while stably moving along a movement path in which a moving line thereof does not overlap that of a person.

### Technical Solution

According to an aspect of the present disclosure, an object recognition device includes: a transfer path including a rail installed above a space in which an object is arranged; a transfer machine configured to move along the rail and lower and support a wire below the rail; and a detector supported by the wire and configured to move up and down to detect and recognize the object.

The detector may include a first camera disposed toward the object on one surface thereof and configured to recognize the object in a captured image.

The object may include an electronic tag, and the detector may include an antenna configured for identifying the electronic tag.

The transfer machine may include a height adjustment unit configured for transferring the detector up and down by adjusting a length of the wire.

The transfer machine and the detector may be connected by a wireless or wired communication means, and the detector may further include a control unit configured for instructing an operation of the transfer machine using the communication means.

The rail may include a plurality of position identifiers indicating positions along a lengthwise direction, and the transfer machine may include a position recognition unit configured for recognizing the position identifiers.

At least one of the transfer machine and the detector may be individually powered, and the object recognition device may further include a charger disposed on one side of the rail and configured for charging at least one of the transfer machine and the detector.

The detector may include a collision detection unit configured for detecting an impact from an outside, and the collision detection unit may include at least one of a contact sensor configured for detecting contact with an obstacle and a gyro sensor configured for detecting a change in a posture of the detector.

The detector may include a display and a second camera disposed toward the user on the other surface thereof and may be configured to recognize the user through the second camera and provide information to the user through the display.

The detector may further include a voice recognition unit for recognizing a request of the user, and the transfer machine may move the detector toward the user when the request of the user is recognized.

The detector may be inclined so that at least a portion thereof may adjust an arrangement angle with respect to the object.

The transfer machine may include a frame movably supported on the rail; a first support plate fixedly installed on the frame and having a first through-hole formed therein; and a second support plate installed on the frame in a hinge structure that pivots up and down and having a second through-hole formed therein, wherein the wire may pass through the first through-hole and then through the second through-hole and be connected to the detector, and the detector may be off-set in a direction perpendicular to the rail by rotating the second support plate.

The object recognition device may further include an off-set bar disposed to intersect the rail and interposed between the rail and the transfer machine, wherein the off-set bar may be installed on the rail to move along the lengthwise direction of the rail, and the transfer machine may be installed on the off-set bar to move along a lengthwise direction of the off-set bar.

### Advantageous Effects

According to the exemplary embodiment of the present disclosure, since the device moves in the air rather than on the floor, it is possible to efficiently detect the target article while the moving line of the device does not overlap the people.

Further, if necessary, the user may provide information on the article and enable two-way communication with a clerk and the like.

Further, the detector may be adjusted to an optimal angle relative to the object and moved to an optimal distance with respect to the object so that the target article may be more efficiently detected.

### DESCRIPTION OF DRAWINGS

FIG. 1 is a perspective view illustrating an object recognition device according to an exemplary embodiment of the present disclosure;

FIG. 2 is an illustration showing the inside of a transfer path in the object recognition device according to an exemplary embodiment of the present disclosure;

FIG. 3 is a perspective view illustrating a transfer machine of the object recognition device according to an exemplary embodiment of the present disclosure;

FIGS. 4 and 5 illustrate a detector of the object recognition device according to an exemplary embodiment of the present disclosure;

FIG. 6 illustrates a first installation example of the object recognition device according to an exemplary embodiment of the present disclosure;

FIG. 7 illustrates a second installation example of the object recognition device according to an exemplary embodiment of the present disclosure;

FIG. 8 illustrates an arrangement angle adjustment of the detector in the object recognition device according to an exemplary embodiment of the present disclosure;

FIG. 9 illustrates a first example of offset movement in the object recognition device according to an exemplary embodiment of the present disclosure;

FIG. 10 illustrates a second example of offset movement in the object recognition device according to an exemplary embodiment of the present disclosure; and

FIGS. 11 to 13 illustrate an object recognition device according to another exemplary embodiment of the present disclosure.

### BEST MODE

An object recognition device according to exemplary embodiments of the present disclosure will be described in detail with reference to the accompanying drawings. In describing the electronic tag identification device according to the exemplary embodiments of the present disclosure with reference to the accompanying drawings, components that are the same as or correspond to each other will be denoted by the same reference numerals, and any redundant description thereof will be omitted.

In addition, terms such as “first,” “second,” and the like used below are merely reference numerals for distinguishing the same or corresponding components, and the same or corresponding components are not limited by the terms such as “first,” “second,” and the like.

In addition, the term “coupled” is used as a concept including not only a case in which a physical contact is directly made between the respective components but also a case in which another component is interposed between the respective components and each of the components is in contact with another component, in a contact relationship between the respective components.

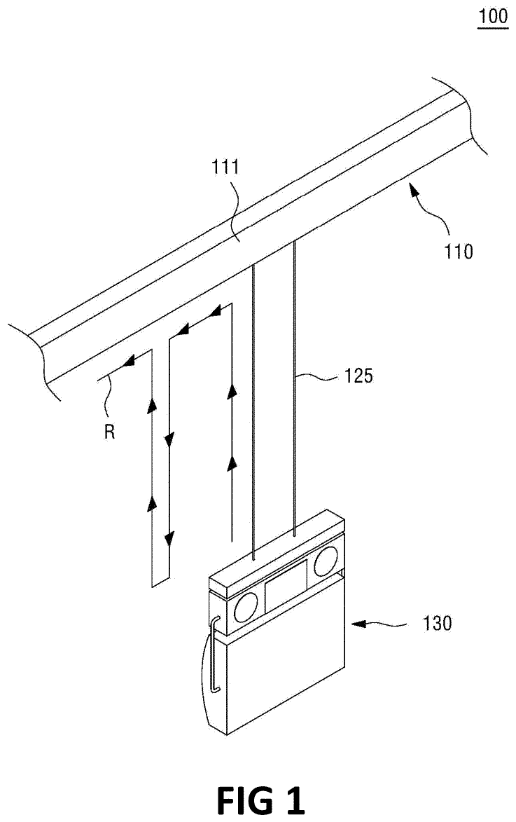

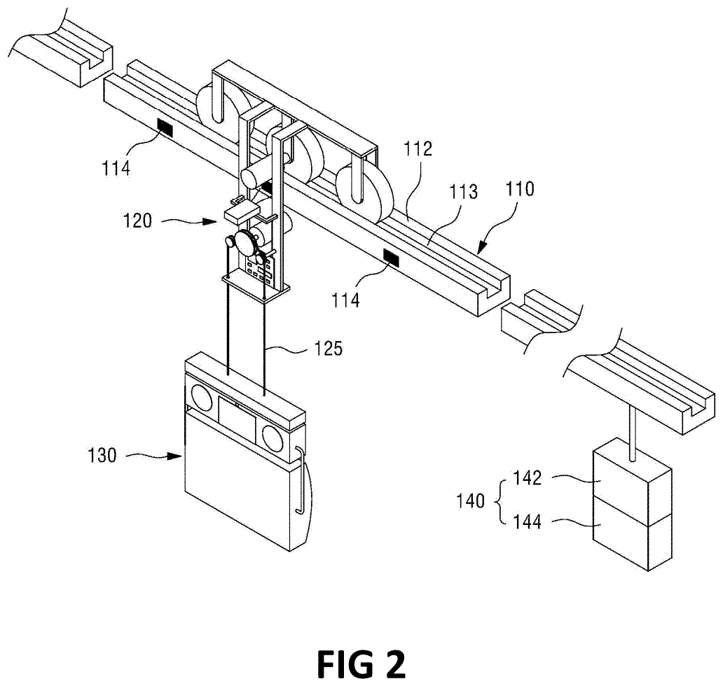

FIG. 1 is a perspective view illustrating an object recognition device according to an exemplary embodiment of the present disclosure, and FIG. 2 is an illustration showing the inside of a transfer path in the object recognition device according to an exemplary embodiment of the present disclosure.

An object recognition device 100 according to an exemplary embodiment of the present disclosure includes a transfer path 110, a transfer machine 120, and a detector 130.

The transfer path 110 provides a path through which the transfer machine 120 for transferring the detector 130 moves. The transfer machine 120 includes a rail 112 installed on a space in which an object is disposed.

Referring to FIG. 2, in the present exemplary embodiment, a straight rail 112 in which a groove 113 is formed on an upper surface thereof is provided. The groove 113 of the rail 112 forms a path through which the wheels 123 of the transfer machine 120, which will be described later, are inserted and moved.

Referring to FIG. 1, the rail 112 and the transfer machine 120 moving on the rail 112 may be covered by a cover 111.

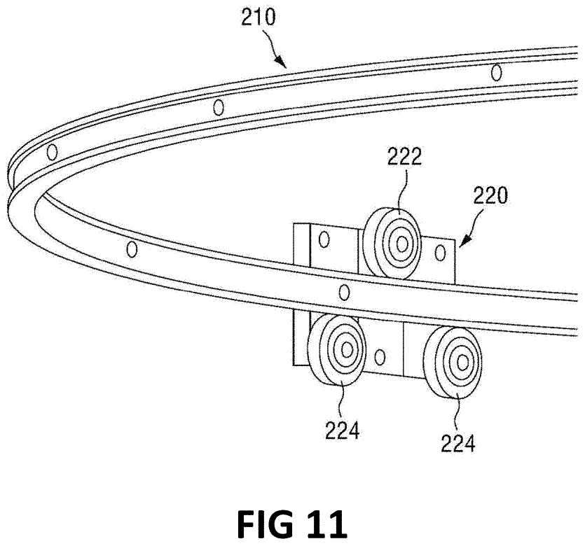

Meanwhile, although the linear transfer path 110 is described in the present exemplary embodiment, the transfer path is not limited thereto, and a transfer path 210 (see FIG. 11) may have a curved section. In addition, the transfer path may have a plurality of paths that also intersect each other.

The transfer machine 120 moves along the rail 112 and supports a wire 125 holding the detector 130. Specifically, the transfer machine 120 lowers the wire 125 below the rail 112 and supports the wire 125.

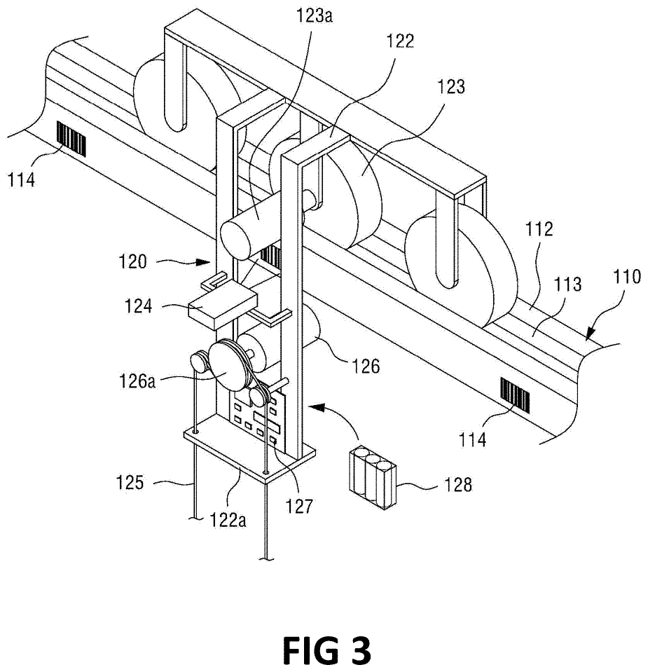

FIG. 3 illustrates a transfer machine of the object recognition device according to an exemplary embodiment of the present disclosure.

Referring to FIG. 3, the transfer machine 120 of the present embodiment may include a frame 122 movably supported on the rail 112. Specifically, wheels 123 fitted into the groove 113 of the rail 112 and a first motor 123a for driving the wheels 123 may be installed in the frame 122.

In addition, referring to FIG. 11, in another exemplary embodiment of the present disclosure, a transfer machine 220 may have a structure in which wheels 222 and 224 are in contact with both the upper and lower surfaces of the rail 210. Since a structure is made such that the wheels 222 and 224 of the transfer machine 220 face each other with the rail 210 interposed therebetween and holds the rail 210, it is possible to prevent the wheels 222 and 224 of the transfer machine 220 from sliding on the rail 210.

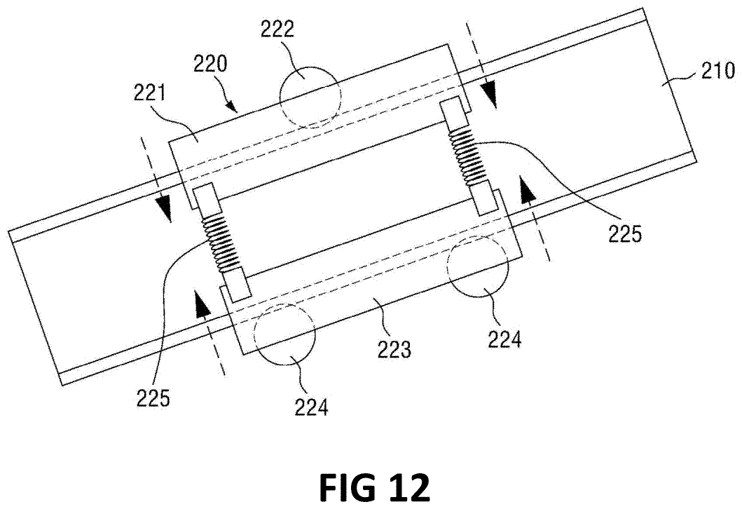

In particular, referring to FIG. 12, the upper wheel 222 of the transfer machine 220 and the lower wheel 224 of the transfer machine 220 may have a structure of elastically tightening the rail 210. For example, in the transfer machine 220, a second body 223, in which the lower wheel 224 is installed, may be connected to a first body 221, in which the upper wheel 222 is installed, by an elastic member 225. At this time, the elastic member 225 serves to pull the second body 223 toward the first body 221 so that the upper wheel 222 and the lower wheel 224 may elastically press the rail 210 upwardly and downwardly. Accordingly, since a slip phenomenon of the upper wheel 222 and the lower wheel 224 sliding on the rail 210 is more effectively prevented, the transfer machine 220 may smoothly run even on a slope.

Meanwhile, referring to FIG. 11, in the transfer machine 220, the upper wheel 222 becomes a driving wheel to which a motor or the like is connected, and the lower wheel 224 may be a driven wheel provided in a pair and arranged in a triangular structure with the upper wheel 222. Accordingly, even in the curved section of the rail 210, the transfer machine 220 may smoothly run without being separated.

The transfer machine 120 may confirm a position in the transfer path 110. Specifically, the rail 112 may include a plurality of position identifiers 114 indicating positions along a lengthwise direction, and the transfer machine 120 may include a position recognition unit 124 for recognizing the position identifiers 114.

Referring to FIG. 3, in the present exemplary embodiment, barcodes arranged at regular intervals may be formed on the rail 112, and a barcode reader may be installed on the frame 122. Since the barcode has position information on the transfer path 110, the transfer machine 120 may recognize the barcode and confirm the position of the transfer machine 120. Although the barcode is described as the position identifier 114 in the present exemplary embodiment, the position identifier 114 is not limited thereto and may include various types such as electronic tags and magnetic stickers.

In addition, the transfer machine 120 may adjust a height of the detector 130. For example, the transfer machine 120 may include a height adjustment unit for transferring the detector 130 up and down by adjusting a length of the wire 125.

Referring to FIG. 3, the height adjustment unit of the present exemplary embodiment may include a second motor 126 installed on the frame 122 and a reel 126a coupled to the second motor 126 and wound with the wire 125. For example, a middle portion of the wire 125 may be wound on the reel 126a, and both ends of the wire 125 may be coupled to the detector 130. Accordingly, it is possible to increase or decrease the length of the wire 125 supporting the detector 130 and to raise or lower the detector 130 coupled to both ends of the wire 125 by winding or unwinding the reel 126a according to the operation of the second motor 126. Therefore, by controlling the second motor 126, the transfer machine 120 may adjust the height of the detector 130.

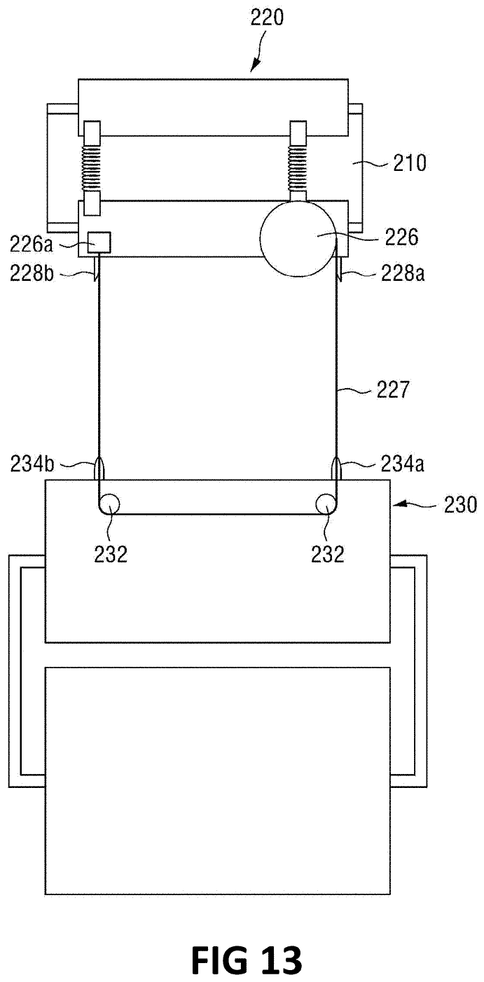

In addition, referring to FIG. 13, in another exemplary embodiment of the present disclosure, the height adjustment unit may include a reel 226 installed on a transfer machine 220 and coupled to one end of a wire 227. The other end of the wire 227 may be fixed to a fixing unit 226a of the transfer machine 220.

Here, a pulley 232 that is rotatable such that the wire 227 may pass through may be installed in the detector 230. Specifically, the pulley 232 of the detector 230 may be installed in a structure supported by being caught on the wire 227 connected to the reel 226. In particular, a pair of pulleys 232 are symmetrically disposed on either side of the detector 230, and the wire 227 sequentially passes through the pair of pulleys 232, so that the pair of pulleys 232 may be installed in a structure supported by being caught on the wire 227.

Accordingly, by winding or unwinding the reel 226, a length of the wire 227 supporting the detector 230 may increase or decrease, and the detector 230 supported on the wire 227 may be raised or lowered. In addition, when the length of the wire 227 is varied, a left-and-right balance of the detector 230 may also be automatically adjusted through the pair of rotating pulleys 232.

Although the structure is described in the above-described embodiments that the height adjustment unit is installed in the transfer machine 120, the height adjustment unit may also be installed in the detector 130, which will be described later. That is, the length of the wire 125 may be adjusted by pulling the wire 125 from the detector 130.

Referring to FIG. 1, a detection path R is illustrated through the movement of the transfer machine 120 and the height adjustment of the detector 130. By raising the detector 130 upward when the detector 130 is horizontally moved, it is possible to prevent the detector 130 from shaking during movement. In other words, in order to prevent rolling of the detector 130 during horizontal movement, it is preferable to shorten the wire 125 by raising the detector 130 and then to move the transfer machine 120 to horizontally move the detector 130 and to adjust the height.

In addition, the transfer machine 120 may be powered individually so as to be movable by itself without being connected to the outside.

Referring to FIG. 3, for example, electronic components (a first motor 123a, a second motor 126, a barcode reader, etc.) of the transfer machine 120 and a board 127 for controlling the electronic components may be powered by a battery 128 installed on the frame 122. In addition, the detector 130, which will be described later, may also be powered individually a similar manner.

Here, at least one of the transfer machine 120 and the detector 130 may be charged with a charger 140 disposed on one side of the rail 112.

Referring to FIG. 2, the charger 140 having wireless charging modules 142 and 144 for charging the transfer machine 120 and the detector 130, respectively, may be installed at one end of the rail 112. Although the transfer machine 120 or the detector 130 is described to be wirelessly charged in the present exemplary embodiment, the transfer machine 120 or the detector 130 may also be charged by being in direct contact with the charger 140.

In addition, in another exemplary embodiment of the present disclosure, the charging may also be made between the transfer machine 220 and the detector 230. That is, the transfer machine 220 may charge the detector 230, or conversely, the detector 230 may charge the transfer machine 220.

Referring to FIG. 13, the transfer machine 220 may include a pair of first charging terminals 228a and 228b, and the detector 230 may include a pair of second charging terminals 234a and 234b disposed to correspond to the pair of first charging terminals 228a and 228b. Accordingly, when the detector 230 rises and is disposed in proximity to the transfer machine 220, the first charging terminals 228a and 228b and the second charging terminals 234a and 234b may be in contact with each other according to polarity and may be charged with each other.

The detector 130 serves to detect and recognize an object. The detector 130 may move up and down by being supported by the wire 125 and may be horizontally moved along the transfer path 110 by the transfer machine 120 as described above.

The detector 130 may include a first camera 133, which is disposed toward the object on one surface thereof and configured to recognize the object in a captured image, so as to detect and recognize the object.

In addition, the detector 130 may include an antenna 134 for identifying the electronic tag to detect and recognize the object. In such a case, the object is provided with the electronic tag.

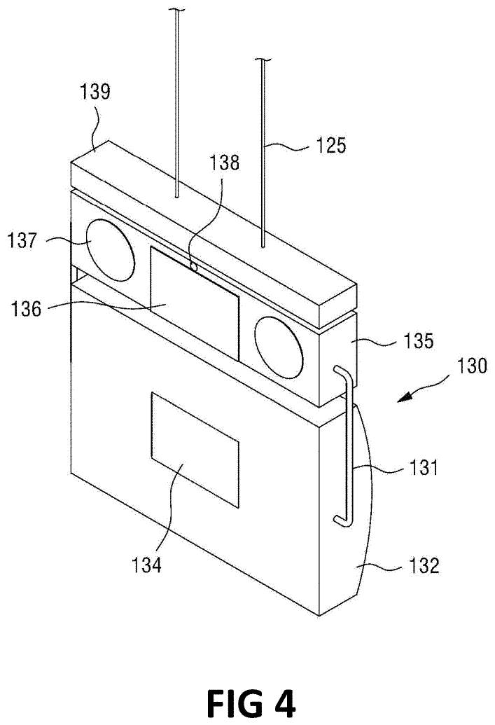

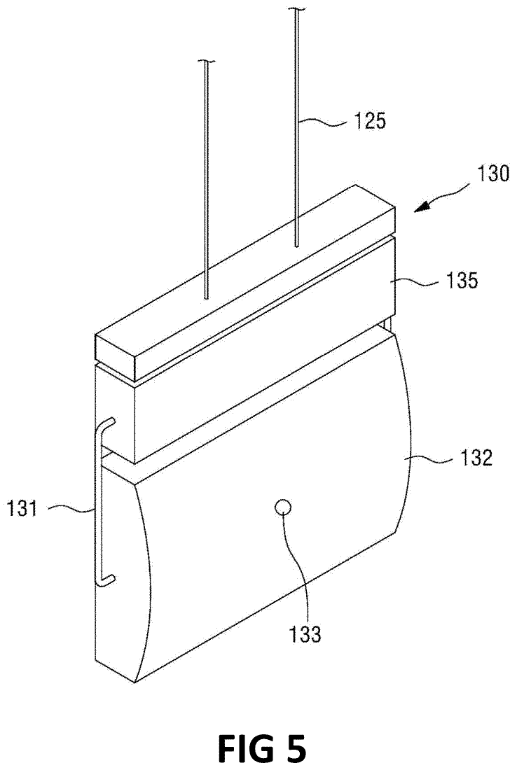

FIGS. 4 and 5 illustrate a detector of the object recognition device according to an exemplary embodiment of the present disclosure.

Referring to FIGS. 4 and 5, the detector 130 of the present exemplary embodiment may be supported by an upper portion thereof being suspended from the wire 125. In addition, the detector 130 may include one surface facing the object and the other surface facing the user. FIG. 4 illustrates the other surface of the detector 130 facing the user, and FIG. 5 illustrates one surface facing the object.

Referring to FIG. 5, the first camera 133 may be disposed on one surface of the detector to capture an image to recognize the object. That is, the detector may detect and recognize the object through vision-based recognition.

Referring to FIG. 4, the detector may also be embedded with an antenna 134 that identifies the electronic tag. For example, radio frequency identification (RFID) may be attached to the object, and the detector may be embedded with the antenna 134 that recognizes the RFID.

In addition, a display 136 and a second camera 138 disposed toward the user may be disposed on the other surface of the detector 130. The second camera 138 may serve to recognize the user. In addition, the display 136 may also provide information recognized through the second camera 138 to the user.

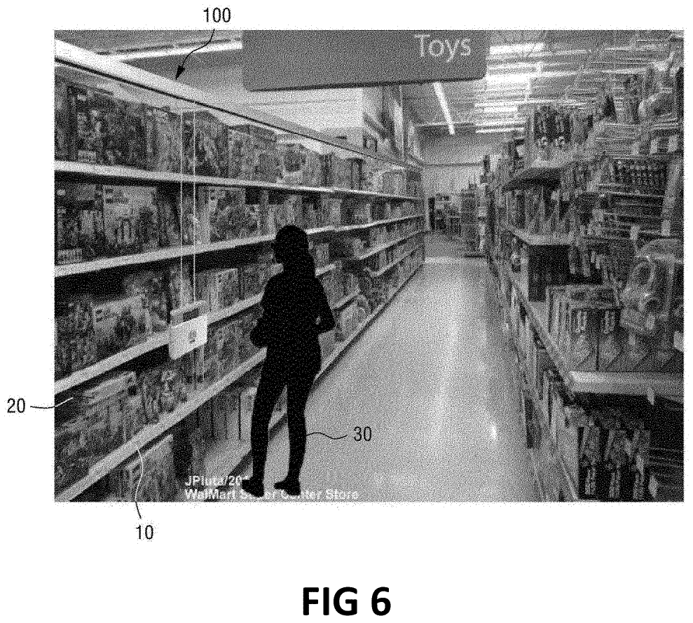

FIG. 6 illustrates a first installation example of the object recognition device according to an exemplary embodiment of the present disclosure.

Referring to FIG. 6, the object recognition device 100 of the present exemplary embodiment may be installed on a shelf 10 disposed in a market or warehouse. For example, in the front of the shelf 10 to which an article 20, which is the object, is exposed, the transfer path 110 may be installed lengthwise along the shelf 10 at an upper side. Accordingly, by raising and lowering the detector 130 while the transfer machine 120 moves along the transfer path 110, the detector 130 may recognize the article 20 placed on the shelf 10 through the vision-based recognition or the electronic tag. Therefore, the movement of the detector 130 does not overlap with a moving line of a person, and the detector 130 may reliably and efficiently detect the article 20, which is the object, while stably moving along the movement path.

In addition, the detector 130 may provide information of the article 20 to the user, if necessary. When the user is recognized through the second camera 138, the display 136 may provide information associated with the article 20. For example, the display 136 may provide advertisements related to the article 20.

In addition, the detector 130 may further include a voice recognition unit 137 for recognizing a request made by the user. Accordingly, two-way communication with the user may be realized through the voice recognition unit 137. For example, when there is a request made by the user, the voice recognition unit 137 may recognize the user's request, and the transfer machine 120 may move the detector 130 toward the user. In addition, the detector 130 uses the second camera 138, the voice recognition unit 137, and a speaker to connect with a clerk in another place so that the user may inquire of the clerk for necessary information and the clerk may provide the necessary information.

The transfer machine 120 and the detector 130 may be connected by a wireless or wired communication means, and the detector 130 may further include a control unit for instructing the operation of the transfer machine 120 using the communication means. In the present exemplary embodiment, the transfer machine 120 and the detector 130 may be connected by a wireless communication means through Bluetooth or the like. In addition, the detector 130 may include a controller, which is a control unit for controlling the object recognition device 100, and may instruct the transfer machine 120 through the controller.

Meanwhile, the detector 130 may include a collision detector for detecting an impact from the outside.

For example, the collision detector may include a contact sensor 139, which detects a contact with an obstacle. Referring to FIG. 4, the contact sensor 139 is installed on an upper portion of the detector 130, and when the detector 130 collides with an obstacle while rising, it is possible to detect the collision with the obstacle and stop the movement of the detector 130.

In addition, the collision detector may also include a gyro sensor that detects a change in a posture of the detector 130. The gyro sensor measures an angular velocity of the installed target. Therefore, when the posture of the detector 130 is changed due to being pushed by or collided with the obstacle, it is possible to detect the changed posture and stop the movement of the detector 130.

The detector 130 according to the present exemplary embodiment may detect not only objects arranged in a vertical-horizontal plane but also objects arranged in parallel or inclined surfaces on the floor.

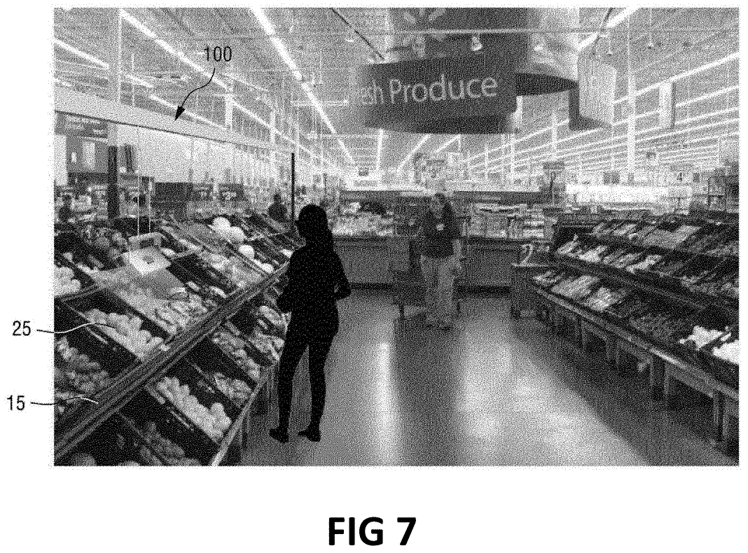

FIG. 7 illustrates a second installation example of the object recognition device according to an exemplary embodiment of the present disclosure.

Referring to FIG. 7, the articles 25 are often arranged diagonally on a stand 15 of a market or the like. In such a case, the detector 130 may be inclined so that at least a portion thereof may adjust an arrangement angle with respect to the object.

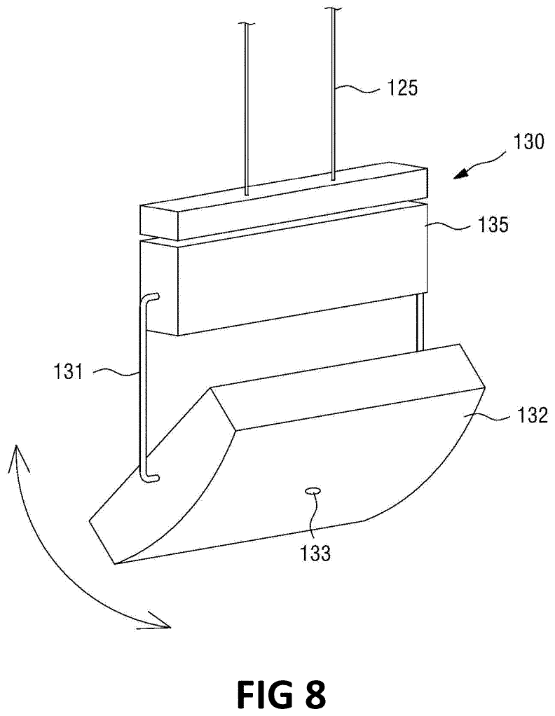

FIG. 8 illustrates an arrangement angle adjustment of the detector in the object recognition device according to an exemplary embodiment of the present disclosure.

Referring to FIG. 8, the detector 130 may include a first body 132 and a second body 135, and the first body 132 may be connected to the second body 135 by a hinge structure. For example, the second body 135 may be coupled to the wire 125, and the first body 132 may be rotatably connected to the second body 135 through a hinge shaft 131. In such a case, the second camera 138 or the antenna 134, which is necessary for detection, may be installed on the first body 132 and may be disposed at an optimal angle toward the article 25.

The detector may perform an off-set movement that is moved in a direction perpendicular to or intersecting the transfer path 110.

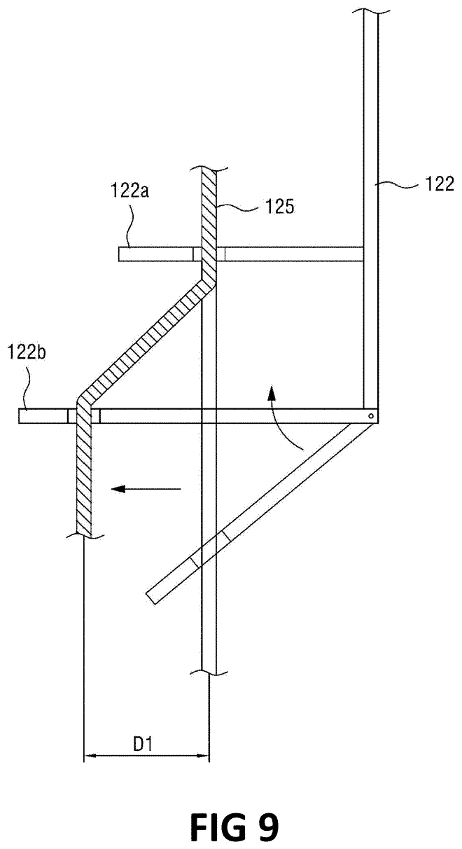

FIG. 9 illustrates a first example of offset movement in the object recognition device according to an exemplary embodiment of the present disclosure.

Referring to FIG. 9, the transfer machine 120 may include a first support plate 122a fixedly installed on the frame 122 and having a first through-hole formed therein and a second support plate 122b installed on the frame 122 in a hinge structure that pivots up and down and having a second through-hole formed therein. In addition, the wire 125 may pass through the first through-hole and then through the second through-hole and may be connected to the detector 130. Accordingly, when the second support plate 122b is rotated, the wire 125 may be moved to be away from or closer to the rail 112. That is, the detector may be off-set moved by a desired distance D1 in a perpendicular direction of the rail 112.

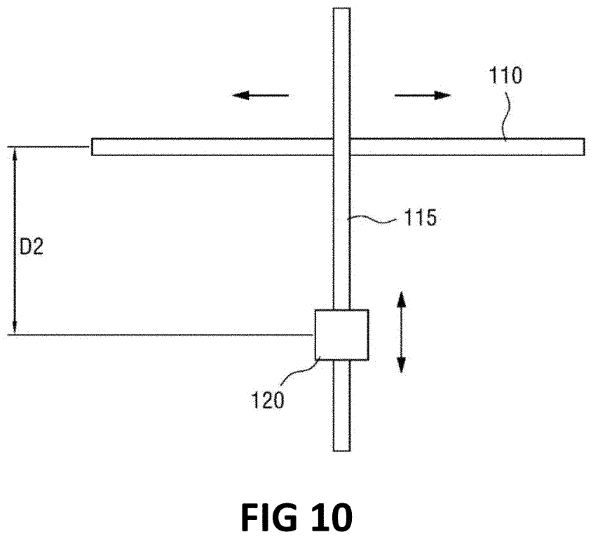

FIG. 10 illustrates a second example of offset movement in the object recognition device according to an exemplary embodiment of the present disclosure.

Referring to FIG. 10, by adding an offset bar 115 between the rail 112 and the transfer machine 120, the detector may be off-set moved by a desired distance D2 in the perpendicular direction of the rail 112. Specifically, the offset bar 115 may be disposed to intersect the rail 112 and may be installed on the rail 112 to move along the lengthwise direction of the rail 112. In addition, the transfer machine 120 may be installed on the offset bar 115 to move along the lengthwise direction of the offset bar 115.

The object recognition devices of the present exemplary embodiment may be installed in plurality and may be managed in an integration manner. For example, the object recognition device may be installed on several shelves and stands in the market, respectively. In addition, the plurality of object recognition devices may be connected to a central processing unit through wired/wireless communication means such as Ethernet or Wi-Fi.

Hitherto, an exemplary embodiment of the present disclosure has been described, but those of ordinary skill in the art may variously modify and change the present disclosure by changing, deleting or adding components within the scope without departing from the spirit of the present invention disclosed in the claims, and it is also within the scope of the present invention.

What is claimed is:

1. An object recognition device comprising:
a transfer path including a rail installed above a space in which an object is arranged;
a transfer machine configured to move along the rail and to lower and support the wire below the rail; and
a detector supported by the wire to move up and down and configured to detect and recognize the object.

2. The object recognition device of claim 1, wherein the detector comprises a first camera disposed on one surface thereof, the first camera being disposed toward the object and configured to recognize the object in a captured image.

3. The object recognition device of claim 1, wherein the object includes an electronic tag, and
wherein the detector includes an antenna configured to identify the electronic tag.

4. The object recognition device of claim 1, wherein the transfer machine comprises a height adjustment unit configured for transferring the detector up and down by adjusting a length of the wire.

5. The object recognition device of claim 4, wherein the transfer machine and the detector are connected by a wireless or wired communication means, and
wherein the detector further comprises a control unit configured for instructing an operation of the transfer machine using the communication means.

6. The object recognition device of claim 1 any one of claims 1 to 4, wherein the rail comprises a plurality of position identifiers configured for indicating positions along a lengthwise direction, and
wherein the transfer machine comprises a position recognition unit configured for recognizing the position identifiers.

7. The object recognition device of claim 1, wherein at least one of the transfer machine and the detector is powered individually, and
wherein the object recognition device further comprises a charger disposed on one side of the rail and configured to charge at least one of the transfer machine and the detector.

8. The object recognition device of claim 1, wherein the detector comprises a collision detection unit configured for detecting an impact from an outside, and
wherein the collision detection unit comprises at least one of a contact sensor configured for detecting a contact with an obstacle and a gyro sensor configured for detecting a change in posture of the detector.

9. The object recognition device of claim 1, wherein the detector comprises a display and a second camera disposed on the other surface thereof, the display and the second camera being disposed toward the user, and
wherein the user is recognized through the second camera, and information is provided to the user through the display.

10. The object recognition device of claim 9, wherein the detector further comprises a voice recognition unit configured for recognizing a request made by the user, and
wherein the transfer machine is configured to move the detector toward the user when the request made by the user is recognized.

11. The object recognition device of claim 1, wherein the detector is inclined in such a way that at least a portion thereof adjusts an arrangement angle with respect to the object.

12. The object recognition device of claim 1, wherein the transfer machine comprises:
a frame movably supported on the rail;
a first support plate fixedly installed on the frame and having a first through-hole formed therein; and
a second support plate installed on the frame in a hinge structure that pivots up and down and having a second through-hole formed therein,
wherein the wire passes through the first through-hole and then through the second through-hole and is connected to the detector, and
wherein the detector is off-set moved in a direction perpendicular to the rail by rotating the second support plate.

13. The object recognition device of claim 1, further comprising an off-set bar disposed to intersect the rail and interposed between the rail and the transfer machine,
wherein the off-set bar is installed on the rail to move along a lengthwise direction of the rail, and
wherein the transfer machine is installed on the off-set bar to move along a lengthwise direction of the off-set bar.
